(19) United States
(12) Patent Application Publication
(10) Pub. No.: US 2005/0052117 A1
(43) Pub. Date: Mar. 10, 2005

(54) Field emission display device

(76) Inventors: Toshifumi Ozaki, Mobara (JP); Tomoki Nakamura, Chiba (JP); Susumu Sasaki, Chiba (JP); Yoshiyuki Kaneko, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/937,551

(22) Filed: Sep. 10, 2004

(30) Foreign Application Priority Data
Sep. 10, 2003 (JP) 2003-318049

(51) Int. Cl. H01J 1/62

(52) U.S. Cl. 313/497

(57) ABSTRACT

A field strength between a control electrode in a non-aperture region and an electron emission layer is set such that an emission current between the electron emission layer and the control electrode assumes a value equal to or less than a threshold emission current density. On the other hand, a surface field strength of the electron emission layer in an aperture region is set such that, to obtain the desired brightness, an emission current between the electron emission layer and an anode becomes an operational current density.

### CROSS-REFERENCE TO RELATED APPLICATION

The present application claims priority from Japanese application JP2003-318049 filed on Sep. 10, 2003, the content of which is hereby incorporated by reference into this application

### BACKGROUND OF THE INVENTION

1. Field of the Invention

The present invention relates to a field emission display device (FED), and more particularly to an FED which is preferably applicable as a control electrode separation type FED which defines a space between electron emission layers and control electrodes. Further, the present invention relates to an FED which is preferably applicable as an FED using CNT (carbon nanotubes) as electron sources, and also relates to an FED which is preferably applicable as a CNTFED which includes control electrodes on electron emission layers.

2. Description of the Related Art

In JP-A-2001-143604 (Patent Document 1), there exists a description that an electric field present between phosphors on a front face plate and the control electrodes oozes out to an electron source side from apertures formed in the control electrodes and interacts with an electric field present between the electron sources and the control electrodes thus forming a composite electric field. In this Patent Document 1, there also exists a description that a field strength of the composite electric field is changed by changing any one of an applied voltage to the phosphors on the front face plate, an applied voltage to the control electrodes and an applied voltage to the electron sources so as to control an electron emission quantity.

Further, in Patent Document 1, there also exists a description that the composite electric field is formed of equipotential collective lines which are bulged toward the electron source side and hence, the potential difference at valley lines is large so that an electron emission effect at an intersecting portion between the valley line and the electron source is increased, whereby emitted electrons are introduced to the valley lines so as to decrease the lowering of the electron utilization efficiency caused by absorption by the control electrode. The Patent Document 1 also describes that although the above-phenomenon is experimentally confirmed, the relationship between the respective electric fields and the composite electric field and the potential distribution state in the composite electric field is not yet clarified.

Here, in JP-A-2003-16914 (Patent Document 2), there exists a description of a field emission type display device which is provided with an electrode structural body which focuses emission electron beams. In Japanese Patent No. 2809129 (Patent Document 3), there exists a description of a display device which provides an electron beam forming (control) electrode and an electron pull-out (accelerating) electrode on the electron beam forming electrode by way of an insulation layer. Still further, In JP-A-2002-216679 (Patent Document 4), there exists a description of light emitting elements in which a row of planar control electrodes are arranged on a row of cold cathodes in an intersecting manner. Still further, a light emitting device which has an insulation layer between the control electrode and the back surfront face plate is described in Y. Tomihari, F. Ito, Y. Okada, K. Konuma and A. Okamoto, “Multi-Layered red Triode Development for CNT FED”, IDW′ 01 Technical Digest, p1213 (2001)).

### SUMMARY OF THE INVENTION

In the related art of the invention, to decrease a grid current by performing a triode operation well known in a CRT, it is necessary to elevate an anode voltage and, at the same time, to narrow a gap between the electrodes and hence, there has been a drawback that the emission current density and the focusing characteristics are not compatible.

The above-mentioned drawback is a drawback which arises in the triode operation which adopts the emission of thermal electrons on premise. In the triode operation which is performed on the premise of the emission of thermal electrons, to decrease the grid current which generates by the emission of electrons even when the electric field is not generated, it is necessary to set a grid voltage to a value equal to or lower than a cathode voltage. In the field emission, unless the field strength assumes a given value or more, the emission of electrons is not generated and hence, the above-mentioned drawback can be overcome by setting the grid voltage to a value equal to the cathode voltage or more.

The field emission display device of the present invention includes a plurality of cathode lines having electron sources, a plurality of control electrodes which are arranged to intersect the cathode lines and have aperture regions which allow electrons to pass therethrough, a back face plate having a back face substrate, and a front face plate which has an anode and phosphors.

The control electrode includes the aperture regions which allow the electrons to pass therethrough and non-aperture regions which connect the aperture regions.

The value of the field strength between the control electrode and the electron source in the non-aperture region is set such that an emission current density between the electron source and the control electrode assumes a value equal to or below an emission current density between the electron source and the anode.

The value of a surface field strength of the electron source in the aperture region is a value which corresponds to an operational current density which can obtain a given brightness in accordance with the emission current which flows between the electron source and the anode.

### BRIEF DESCRIPTION OF THE DRAWINGS

FIG. 1 is a plan view of a back face plate in a field emission display device;

FIG. 2 is a partial cross-sectional view of the back face plate taken along a line I-I in FIG. 1 and a cross-sectional view of a front face plate at a portion thereof corresponding to the back face plate;

FIG. 3 is a view showing an operational voltage;

FIG. 4 is a potential diagram;

FIG. 5 is a view showing the relationship between a field strength and an emission current density;

FIG. 6 is a cross-sectional view of the back face plate taken along a line I-I in FIG. 1 for explaining an embodiment 2;

FIG. 7 is a cross-sectional view of the back face plate taken along a line I-I in FIG. 1 for explaining an embodiment 3;

FIG. 8 is a cross-sectional view of the back face plate taken along a line I-I in FIG. 1 for explaining an embodiment 4;

FIG. 9 is a cross-sectional view of the back face plate taken along a line I-I in FIG. 1 for explaining an embodiment 5;

FIG. 10 is a cross-sectional view of the back face plate taken along a line I-I in FIG. 1 for explaining an embodiment 6;

FIG. 11 is a cross-sectional view of a portion corresponding to a portion indicated by P1 in FIG. 2 of a pixel which emits electrons for explaining an embodiment 7;

FIG. 12 is a partial cross-sectional view showing the constitution of an anode formed on a front face plate.

### DETAILED DESCRIPTION OF THE INVENTION

The first feature of the present invention lies in that the field emission display device is comprised of a back face plate which includes a plurality of cathode lines 1 having electron sources 2, a plurality of control electrodes 3 which are arranged to intersect the cathode lines 1 and a back face substrate 5, and a front face plate which includes an anode 12 and phosphors 10. Here, the control electrode 3 includes a non-aperture region 34 between apertures 31 which allow electrons to pass therethrough. A field strength Eg between the control electrodes 3 at the non-aperture region 34 and the electron sources 2 is set to a value such that an emission current density between the electron sources 2 and the control electrodes 3 becomes equal to or below an emission current density between the electron sources 2 and the anode 12. The value of a surface field strength Es of the electron sources 2 which face the apertures 31 is a value which corresponds to an operational current density with which a desired brightness is obtained by the emission current which flows between the electron sources 2 and the anode 12.

Due to such a constitution, in the non-aperture region or the like where the composite electric field is not generated, it is possible to set a reactive current which flows in the control electrodes to a small value which is ignorable compared to an active current which flows between the cathode and the anode. Accordingly, the present invention can reduce the power consumption of the field emission display device. Further, the most of the current which flows into the cathode lines 1 flows between the cathode and the anode and hence, the brightness control can be facilitated at the time of driving the current.

Further, in addition to the above-mentioned constitution, the value of the field strength between the control electrode 3 in the non-aperture region 34 and the electron source 2 is set to a value corresponding to the vicinity of a threshold emission current density Ith.

Due to such a constitution, it is possible to set the value of the electric field between the electron source and the control electrode to a maximum value within a range in which the reactive current which flows in the control electrode is ignored. Accordingly, in the acquisition of the necessary operational current density, it is possible to reduce the field strength between the phosphors and the control electrodes whereby the occurrence of the discharge phenomenon can be reduced. Further, the difference between the field strength between the electron sources and the control electrodes and the field strength between the plate-like phosphors and the control electrodes becomes small and hence, it is possible to prevent the electron beams from being excessively focused and being spread thus realizing the high resolution and high color purity.

Further, in addition to the above-mentioned constitution, the control electrode 3 is formed of a plate-like member and an insulation layer is provided to the electron source side of the plate-like member.

Due to such a constitution, even when the distance between the electron source and the plate-like member control electrode is made small by providing the insulation layer to the plate-like member control electrode, a short-circuiting is not generated between the plate-like member control electrode and the electron source and hence, a high yield rate can be realized.

Further, in addition to the above-mentioned constitution, the control electrode 3 has an electrode structural body which surrounds the electron emission region 33 of the control electrode.

Due to such a constitution, by providing such an electrode structural body to the control electrode, the loci of electrons which are emitted from the aperture close to the electrode structural body are bent or deflected toward the center of the pixel. Accordingly, even when a focusing action of the control electrode is not sufficient with respect to the divergence held by the electron source per se, there is no possibility that the electron beams make the phosphor of the neighboring pixel emit light and hence, the lowering of the resolution and the color purity can be prevented.

Further, in addition to the above-mentioned constitution, the control electrode has an acceleration electrode 50 thereon by way of an insulation layer 51.

Due to such a constitution, the composite electric field is formed of the electric field generated between an acceleration electrode and the control electrode. Accordingly, a surface field strength of an electron emission layer which determines the emission current is not influenced by the field strength between the phosphor and the control electrode whereby it is possible to independently set the emission current value to the phosphor and the acceleration voltage at the time that the electrons impinge on the phosphor. Eventually, it is possible to set the optimum brightness.

Further, according to the above-mentioned constitution, it is sufficient to merely set the acceleration voltage at a predetermined value in setting the brightness. Since the distance between the back face plate and the front face plate can be increased without considering the field strength, it is possible to reduce the occurrence of the vacuum evacuation resistance and the discharge phenomenon

The second feature of the present invention lies in that the field emission display device comprises a back face plate which includes a plurality of cathode lines 1 having electron sources 2, a plurality of control electrodes 3 being arranged over the cathode lines 1 in a transverse manner and having aperture regions 31 which allow electrons to pass therethrough and a back face substrate 5, and a front face plate which includes an anode 12 and phosphors 10, wherein the control electrodes 3 are formed of a plate-like member having leg portions 32 and an insulation layer 20 is formed over the back face substrate except for positions where the leg portions 32 are adhered.

Due to such a constitution, since a distance between the electron source and the plate-like control electrode can be shortened by a film thickness of the insulation layer formed over the back face plate, the influence that an electric field which is oozed out to the electron source side through apertures formed in the control electrode affects the surface of the electron source is increased and hence, it is possible to reduce a field strength between the phosphors on the front face plate and the control electrode which is necessary for obtaining the required operational current density. Accordingly, the field emission display device of the present invention can reduce the discharge phenomenon. Further, according to the field emission display device of the present invention, the influence of a voltage applied to the control electrode on the electron source is also increased and hence, a voltage amplitude of the control electrode and a voltage amplitude of the cathode lines required for turning on and off of the electron emission can be decreased and hence, drive circuits can be manufactured as a low cost.

Further, according to the field emission display device of the present invention, at the time of adhering the plate-like control electrode to the back face substrate, since the leg portions of the plate-like control electrode are fitted into gaps of the insulation layer formed on the back face substrate except for the positions where the leg portions of the plate-like control electrodes are adhered, it is possible to perform the positioning of the plate-like control electrodes and the cathode lines formed over the insulation layer with high accuracy.

Embodiments of the present invention are explained in detail hereinafter.

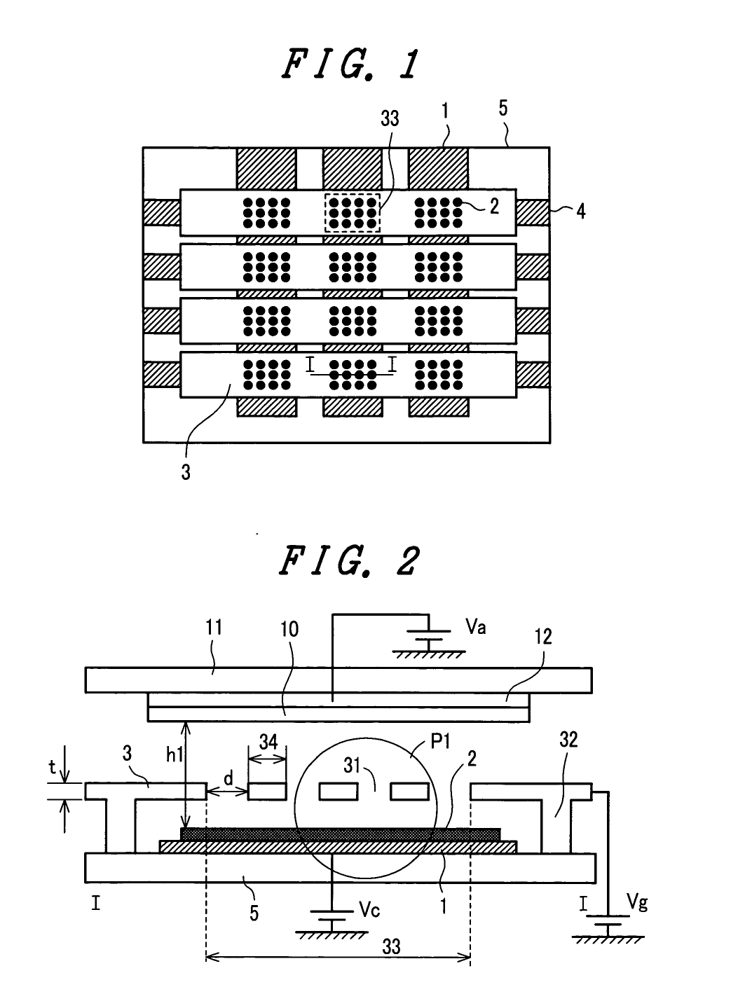

An embodiment 1 is explained in conjunction with FIG. 1 to FIG. 5.

FIG. 1 is a plan view of a back face plate in the field emission display device. FIG. 2 is a partial cross-sectional view of the back face plate taken along a line I-I in FIG. 1 and a cross-sectional view of a front face plate corresponding to the back face plate. Numeral 1 indicates cathode lines 1 made of silver, numeral 2 indicates electron sources (electron emission layers) made of carbon nanotubes (CNT), numeral 3 indicates control electrodes which are formed of a thin plate member made of iron, iron alloy or the like, numeral 31 indicates electron passing holes (apertures) which are formed in the control electrodes 3 formed of the thin plate member, numeral 32 indicates leg portions which project toward the back face substrate side from the plate members, numeral 4 indicates control electrode lead lines which are made of silver and are connected with the control electrodes 3, numeral 5 indicates a back face substrate made of glass, numeral 10 indicates phosphors, numeral 11 indicates a front face substrate having light transmitting property made of glass, and numeral 12 indicates an anode which is formed on the front face substrate 11. The anode 12 is formed over the whole image display region of the front face substrate 11. Here, the anode 12 is formed of a transparent conductive film made of ITO or the like. Further, a conductive thin film may be formed on a cathode side of the phosphors 10. The back face plate is also referred to as a cathode plate and the cathode lines 1, the electron sources 2 and the control electrodes 3 are formed on the back face substrate 5. On the other hand, the front face plate is also referred to as an anode plate and the anode 12 and the phosphor layers 10 are formed on the front face substrate 11.

One pixel is constituted of an electron emission region 33 which is positioned at an intersecting point between the cathode line 1 and the control electrode 3 and a phosphor screen which faces the electron emission region 33. Symbols Va, Vg, Vc respectively indicate voltages applied to the anode 12, the control electrodes 3 and the cathode lines 1 respectively.

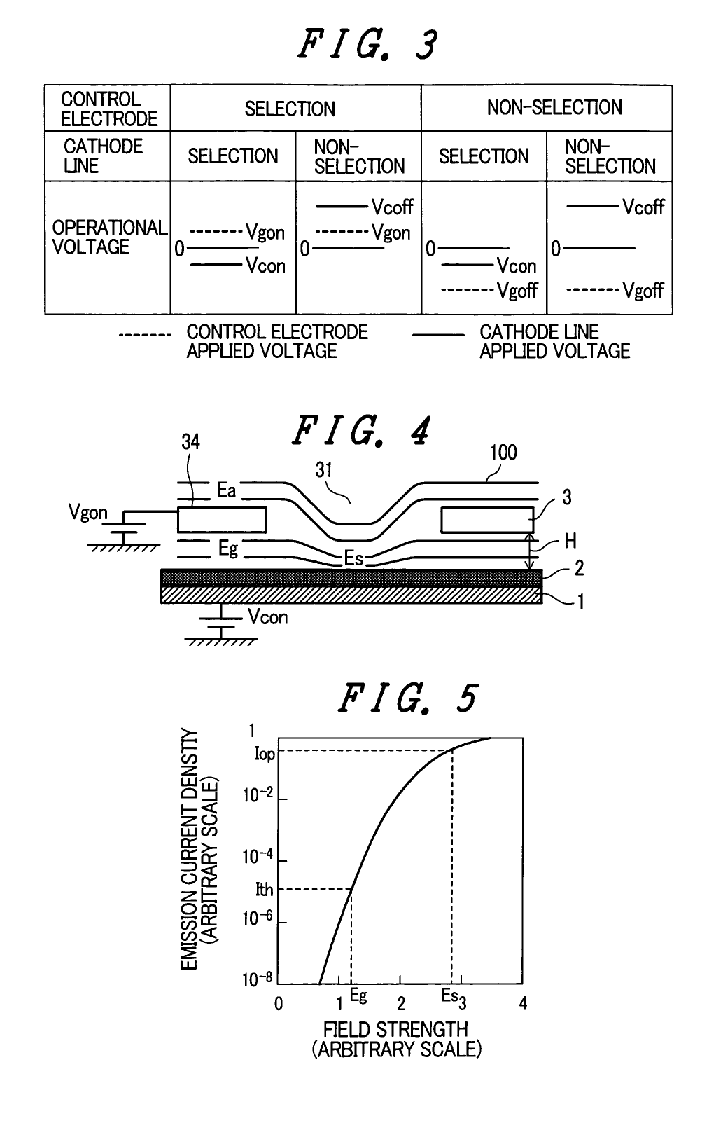

During the operation, the voltages shown in FIG. 3 are applied to the control electrodes 3 and the cathode lines 1 so as to control the electron emission of respective pixels. In emitting electrons, a voltage Vgon is applied to the control electrode of the row selected for electron emission and a voltage Vcon which is lower than the voltage Vgon is applied to the cathode line of the column selected for electron emission.

On the other hand, when the electron emission is not generated, a voltage Vcoff which is higher than the voltage Vgon is applied to the cathode lines 1 of non-selected columns (columns which are not selected for electron emission) or a voltage Vgoff which is lower than the control electrode applied voltage Vgon of the selected row is applied to the control electrodes 3 of non-selected rows (rows which are not selected for electron emission). Since the voltage Vgoff is lower than the cathode line applied voltage Vcon of the selected column, the electron emission is suppressed.

When the voltage Vg which is applied to the control electrodes 3 is higher than the voltage Vc which is applied to the cathode lines 1, that is, when the relationship of voltage Vgon of control electrode>voltage Vcon of cathode line is established, the electrons are emitted and the phosphors emit light.

FIG. 4 is a potential diagram of the pixel which emits electrons at a portion indicated by P1 in FIG. 2. Numerals 1, 2, 3, 31 indicate parts identical with the parts shown in FIG. 1 and FIG. 2, wherein numeral 100 indicates equipotential lines. Due to the differential voltage between the applied voltage Vgon of the control electrodes 3 and the applied voltage Vcon of the cathode lines 1, an electric field having a field strength Eg is generated between the control electrode 3 at the non-aperture region 34 and the electron emission layer 2.

Further, the electric field having the field strength Ea which is present between the phosphor 10 on the front face plate and the control electrode 3 is oozed out to the electron emission layer 2 side through the apertures 31 formed in the control electrode 3 and acts on an electric field which is generated between the electron emission layer 2 and the control electrode 3. Eventually, the composite electric field is generated.

The composite electric field is formed of a group of equipotential lines which are bulged toward the electron emission layer 2 side, wherein the surface field strength Es of the electron emission layer 2 at the aperture portion becomes larger than the field strength Eg between the control electrode 3 and the electron emission layer 2 at the non-aperture region 34.

Here, as shown in FIG. 2, the control electrode 3 has a plate thickness t of approximately 20 μm, an aperture diameter d of approximately 50 μm to 250 μm. A distance H between the control electrode 3 and the electron emission layer 2 is set to approximately 30 μm or less, and the applied voltage Vg is set to approximately 50V.

Further, the distance hl between the electron emission layer 2 and the phosphors 10 is set to approximately 3 mm and the voltage Va applied to the phosphors 10 is approximately 10 kV.

FIG. 5 is a graph showing the relationship between the field strength and the emission current density of the electron emission layer 2. In a cold cathode in which the carbon nanotubes are used as the electron source, the electron emission occurs when the field strength exceeds a given value.

In FIG. 5, symbol Ith indicates a threshold emission current density. The threshold emission current density Ith is the emission current density when the emission current which flows between the electron source and the control electrode in the non-aperture region assumes a given threshold value. This threshold emission current density Ith is set such that the emission current between the electron source and the control electrode becomes smaller than the emission current between the electron source and the anode for every pixel. For example, assuming the contrast ratio of the display device as 3000, the threshold emission current density Ith is set to be smaller than the inverse number of the contrast ratio (1/3000). Further, the field strength Eg between the control electrode 3 at the non-aperture region and the electron emission layer 2 is set such that the emitted current density becomes equal to or below the threshold emission current density. For example, the field strength Eg is set to fall within a range of 0V/μm<Eg<1.5V/μm, and is more preferably set to 1.2V/μm.

Further, in FIG. 5, Iop is the operational current density for obtaining a desired brightness using the emission electrons which flow from the electron source of each pixel in the aperture region to the phosphors. The composite electric field is formed as a result that the electric field generated between the phosphor screen on the front face plate and the control electrode 3 on the back face plate acts on the electric field generated between the electron emission layer 2 and the control electrode 3. In the composite electric field, the operational current density Iop is determined based on the surface field strength Es of the electron emission layer 2 at the aperture region 31. For example, the surface electric field is set to 2.8V/μm.

As a result, it is possible to set the reactive current which flows in the control electrodes to an extremely small value which can be substantially ignored compared to the active current which flows in the phosphors, that it, 1/3000 of the active current, in the non-aperture regions where the composite electric field is not generated while obtaining the desired brightness whereby the power consumption can be reduced. Further, since it is possible to ignore the current which flows into the control electrodes, the whole current which flows into the cathode lines can be emitted to the phosphors and hence, the brightness control at the time of driving current can be easily performed.

Further, in this embodiment, the field strength Eg is set such that the current density which is emitted by the field strength Eg between the electron emission layer 2 and the control electrode 3 assumes a value in the vicinity of the threshold emission current density Ith. The electric field between the electron emission layer 2 and the control electrode 3 can be maximized within a range that the reactive current which flows into the control electrode 3 can be ignored. Accordingly, the field strength Ea between the phosphor 10 on the front face substrate and the control electrode 3 for obtaining the required operational current density can be decreased whereby the occurrence of the discharge phenomenon can be reduced.

Further, since the difference between the field strength Eg between the electron emission layer 2 and the control electrode 3 and the field strength Ea between the phosphor 10 on the front face substrate and the control electrode 3 becomes small, the curvature of a group of convex equidistant potential lines can be made small. By making the curvature of a group of convex equidistant potential lines small, it is possible to prevent the electron beams from being excessively focused and being spread and hence, the high resolution and the high color purity can be realized.

[Embodiment 2]

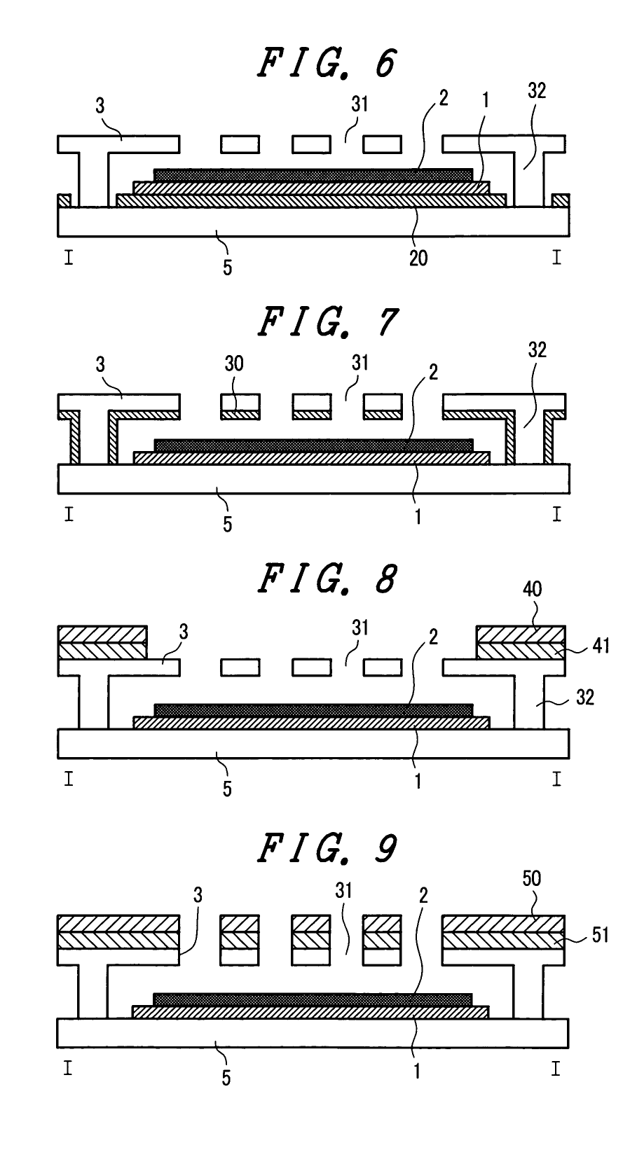

FIG. 6 is a view for explaining an embodiment 2. FIG. 6 is a cross-sectional view of the back face plate taken along a line I-I in FIG. 1, wherein numerals 1, 2, 3, 31, 32, 5 indicate parts identical with the parts shown in FIG. 2, wherein numeral 20 indicates an insulation layer formed on the back face substrate 5. The insulation layer 20 is formed below the cathode lines 1 except for positions where the leg portions 32 of the control electrodes 3 are adhered. By providing the insulation layer 20 below the cathode lines 1, a distance H between the electron emission layer 2 and the control electrode 3 as shown in FIG. 4 can be shortened by a film thickness of the insulation layer 20.

As a result, the influence that the electric field oozed out to the electron emission layer 2 side from the apertures 31 of the control electrodes 3 affects the surface of the electron emission layer 2 in the aperture regions 31 is increased and hence, the field strength Ea between the phosphor 10 and the control electrode 3 necessary for acquiring the required operational current density can be made small whereby the occurrence of the discharge phenomenon can be reduced.

Further, the influence of the voltage applied to the control electrodes 3 on the electron emission layer 2 is also increased and hence, the control electrode voltage amplitude Vgon-Vgoff required for turning on and off the electron emission and the cathode line voltage amplitude Vcon-Vcoff can be made small whereby driving circuits can be manufactured at a low cost.

Further, in adhering the control electrodes 3 to the back face substrate 5, the leg portions 32 of the plate member control electrode 3 are fitted into gaps of the insulation layer 20 and hence, the plate-like member control electrodes 3 and the cathode lines 1 are positioned with high accuracy whereby the resolution of the field emission display device can be highly enhanced.

[Embodiment 3]

FIG. 7 is a view for explaining an embodiment 3. FIG. 7 is a cross-sectional view of the back face plate taken along a line I-I in FIG. 1, wherein numerals 1, 2, 3, 31, 32, 5 indicate parts identical with the parts shown in FIG. 2, wherein numeral 30 indicates an insulation layer formed on the electron source 2 side of the plate-like member control electrodes 3. By providing the insulation layer 30, even when the distance H between the electron emission layer 2 and the control electrode 3 is made small, the short circuiting is not generated between the control electrode 3 and the electron emission layer 2 and hence, the field emission display device can be manufactured with a high yield rate. Further, using polyimide or the like as a material of the insulation layer 30, it is possible to use the insulation layer 30 also as an adhesive material for adhering the plate-like member control electrodes 3 to the back face substrate 5.

[Embodiment 4]

FIG. 8 is a view for explaining an embodiment 4. FIG. 8 is a cross-sectional view of the back face plate taken along a line I-I in FIG. 1, wherein numerals 1, 2, 3, 31, 32, 5 indicate parts identical with the parts shown in FIG. 2, where in numeral 40 indicates a focusing electrode which is formed such that the focusing electrode 40 surrounds the electron emission region which constitutes one pixel, numeral 41 indicates an insulation layer formed between the control electrodes 3 and the focusing electrode 40. The equipotential lines of the apertures 31 through which the electron emission is performed are bulged toward the electron emission layer 2 side as shown in FIG. 4 and the control electrodes 3 focus the emission electrons.

In this embodiment, the loci of the electrons emitted from the apertures particularly close to the focusing electrode 40 are bent toward the center of the pixel due to an electrode structural body constituted of the focusing electrode 40 and the insulation layer 41. Accordingly, even when the distance H between the electron emission layer 2 and the plate-like member control electrode 3 is small and hence and a focusing action by the control electrodes 3 on the divergence which the electron sources per se possess is not sufficient, there is no possibility that the electron beams make phosphors of the neighboring pixel emit light thus lowering the resolution and color purity.

[Embodiment 5]

FIG. 9 is a view for explaining an embodiment 5. FIG. 9 is a cross-sectional view of the back face plate taken along a line I-I in FIG. 1, wherein numerals 1, 2, 3, 31, 5 indicate parts identical with the parts shown in FIG. 2, wherein numeral 50 indicates an acceleration electrode which is formed over the control electrodes 3 by way of an insulation layer 51. The acceleration electrode 50 and the insulation layer 51 are formed also on the control electrodes in the inside of the electron emission regions and an acceleration voltage is applied to the acceleration electrode 50. An electric field generated between the acceleration electrode 50 and the control electrode 3 is oozed out to the electron emission layer 2 side from the apertures 31 formed in the control electrode 3 and acts on the electric field generated between the electron emission layer 2 and the control electrode 3 thus forming a composite electric field.

Accordingly, the surface field strength Es of the electron emission layer 2 which determines an emission current quantity is not influenced by the field strength Ea generated between the phosphor 10 on the front face substrate and the control electrode 3.

Accordingly, the emission current value to the phosphors and the acceleration voltage for making the electrons impinge on the phosphors can be independently set and hence, the brightness can be set to an optimum value. Further, setting of the brightness can be performed by only setting the acceleration voltage to a given value without depending on the field strength and hence, it is possible to reduce the vacuum evacuation resistance and the occurrence of the discharge phenomenon by increasing the distance between the back face plate and the front face plate.

[Embodiment 6]

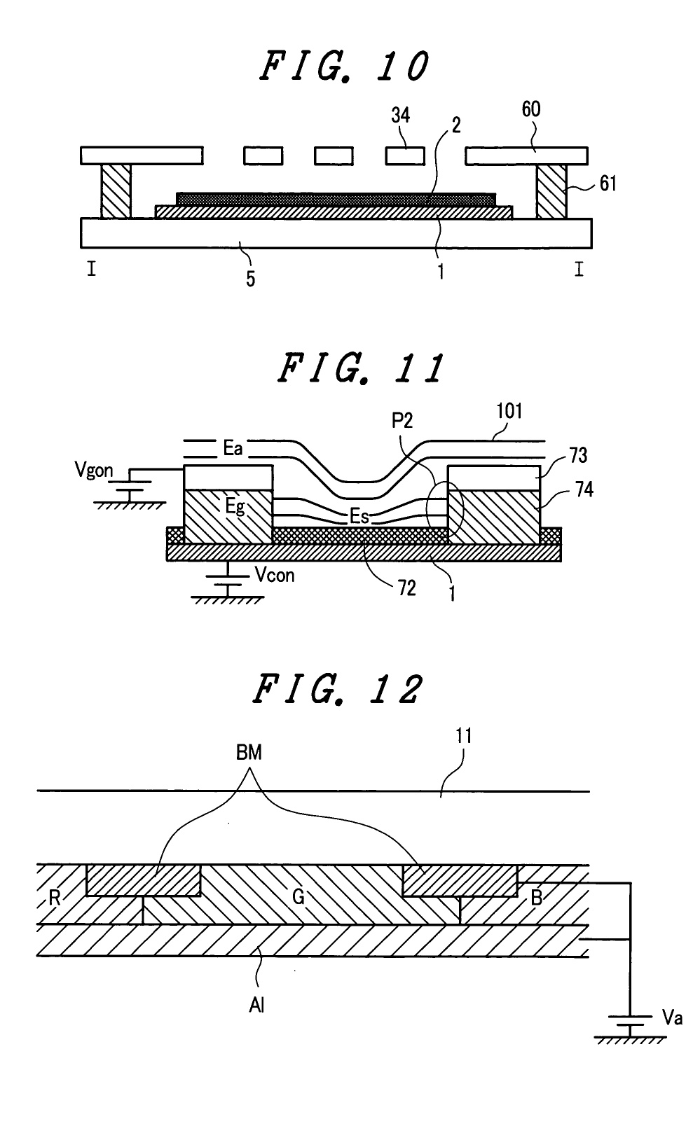

FIG. 10 is a view for explaining an embodiment 6. FIG. 10 is a cross-sectional view of the back face plate taken along a line I-I in FIG. 1, wherein numerals 1, 2, 5,34 indicate parts identical with the parts shown in FIG. 2, wherein numeral 60 indicates plate-like member control electrodes and numeral 61 indicates ribs for supporting the plate-like member control electrodes 60. By setting the field strength Eg between the control electrode 60 at a non-aperture region 34 and the electron emission layer 2 to a value equal to or less than a value which corresponds to the threshold emission current density Ith and by setting the surface field strength Es of the electron emission layer 2 at the aperture regions to a value which corresponds the operational current density Iop, it is possible to set a reactive current which flows in the control electrodes to a small value while obtaining the desired brightness whereby the current consumption can be reduced and the brightness control at the time of driving currents can be performed easily.

[Embodiment 7]

FIG. 11 is a view for explaining an embodiment 7. FIG. 11 is a cross-sectional view of a portion corresponding to the portion indicated by P1 in FIG. 2 of the pixel which emits electrons, wherein numeral 72 indicates electron sources (electron emission layers) made of carbon nanotubes, numeral 73 indicates control electrodes, numeral 74 indicates an insulation layer, and numeral 101 indicates equipotential lines. Further, voltages Vgon, Vcon, Eg, Ea, Es are identical with the corresponding voltages shown in FIG. 4.

Since the electron emission layer 72 is not formed below the non-aperture region of the control electrode 73 and the insulation layer 74 is formed in the non-aperture region of the control electrode 73, the electron emission is not generated. In a peripheral portion of the aperture indicated by P2 in FIG. 11, the emission current between the electron source 72 and the control electrode 73 is controlled such that the emission current assumes a given emission current density (threshold emission current density) or less. Accordingly, the field strength Eg between the non-aperture region of the control electrode 3 and the electron emission layer 2 is set such that the emission current between the electron source 72 and the control electrode 73 assumes the threshold emission current density or less. On the other hand, to obtain the desired brightness, the surface field strength Es of the electron emission layer in the aperture region is set such that the emission current assumes the operational current density Iop. Here, even when the electric field generated between the phosphor 10 on the front face substrate and the control electrode 73 is oozed out to the electron emission layer 2 side from the aperture of the control electrode, the peripheral portion of the aperture (indicated by P2 in the drawing) is not influenced by this electric field.

As a result, even when the electric field generated between the phosphor 10 on the front face substrate and the control electrode 73 is oozed out to the electron emission layer 2 side from the aperture formed in the control electrode, it is possible to set the reactive current between the electron source 72 and the control electrode 73 at the aperture peripheral portion (P2 in the drawing) to a small value which can be substantially ignored compared to the active current between the electron source 72 and anode 12. The present invention can reduce the power consumption while obtaining the desired brightness and hence, can easily perform the brightness control at the time of performing current driving.

With respect to the embodiments described heretofore, in the embodiment 2 shown in FIG. 6, in the same manner as the embodiment 3 shown in FIG. 7, the insulation layer 30 may be provided at the electron source 2 side of the plate-like member control electrodes 3.

In the embodiments 4 to 6 shown in FIG. 8 to FIG. 10, in the same manner as the embodiment 2 shown in FIG. 6, the insulation layer 20 may be formed on the back face substrate 5 made of glass which is disposed below the cathode lines except for the positions where the legs 32 of the plate-like member control electrodes 3 are adhered. Further, in the same manner as the embodiment 3 shown in FIG. 7, the insulation layer 30 may be formed on the electron source 2 side of the plate-like member control electrodes 3. Still further, both of these insulation layers 20, 30 may be formed simultaneously.

In the embodiment 4 shown in FIG. 8, the electrode structural body may be constituted of only the insulation layer 41. It is because that since the dielectric constant of the insulation layer is larger than 1, the similar focusing action is generated even when the focusing electrode 40 is not provided and the loci of the electrons emitted from the apertures close to the insulation layer 41 are bent toward the center of the pixel thus bringing about an advantageous effect that the structure of the electrode structural body can be simplified.

In the embodiments 6, 7 shown in FIG. 10 and FIG. 11, in the same manner as the embodiment 4 shown in FIG. 8, the electrode structural body having the focusing action which is provided to surround the arrangement of apertures of the control electrode in one pixel and includes a conductive body at least a portion thereof may be provided. Further, in the embodiments 6, 7 shown in FIG. 10 and FIG. 11, in the same manner as the embodiment 5 shown in FIG. 9, an acceleration electrode 50 may be formed on the control electrodes by way of an insulation layer 51.

FIG. 12 is a cross-sectional view showing other constitutions of the front face plate. In place of the front face plate described in FIG. 2, a front face plate described in FIG. 12 may be used.

In FIG. 12, symbol BM indicates a black matrix, symbol R indicates a red phosphor layer, symbol G indicates a green phosphor layer, symbol B indicates a blue phosphor layer, and symbol Al indicates a metal back. The metal back Al exhibits an action which is substantially equal to an action of a cathode ray tube. The metal back Al is formed of an aluminum vapor deposition film and guides light which is obtained by the impingement of electron beams on the phosphor toward the outside of the front face substrate 11 efficiently.

The black matrix BM absorbs an external light incident from an observation window side and enhances the contrast of images. Further, the black matrix is positioned at boundary portions of respective phosphor layers (red phosphor layers R, greed phosphor layers G, blue phosphor layers B) thus preventing the emission of light of mixed color of respective colors from being irradiated to a viewer side. Further, the black matrix BM and the metal back Al have the conductivity and an anode is formed by applying an anode potential to the black matrix BM and the metal back Al.

Here, the anode electrode may be formed either one of the black matrix BM or the metal back Al.

1. A field emission display device comprising:
a back face plate which includes a plurality of cathode lines having electron sources, a plurality of control electrodes which are arranged to intersect the cathode lines and a back face substrate; and
a front face plate which includes an anode and phosphors, wherein the control electrode includes a non-aperture region between apertures which allow electrons to pass therethrough, a field strength between the control electrodes at the non-aperture region and the electron sources is set to a value such that an emission current density between the electron sources and the control electrodes becomes equal to or below an emission current density between the electron sources and the anode, and the value of a surface field strength of the electron sources which face the apertures is a value which corresponds to an operational current density with which a desired brightness is obtained by the emission current which flows between the electron sources and the anode.

2. A field emission display device according to claim 1, wherein the control electrode is formed of a plate-like member and an insulation layer is provided to the electron source side of the plate-like member.

3. A field emission display device according to claim 1, wherein the control electrode has an electrode structural body which surrounds an electron emission region which is formed of a plurality of collected apertures of the control electrode and constitutes one pixel.

4. A field emission display device according to claim 1, wherein, the control electrode has an acceleration electrode thereon by way of an insulation layer.

5. A field emission display device according to claim 2, wherein the control electrode has an electrode structural body which surrounds an electron emission region which is formed of a plurality of collected apertures of the control electrode and constitutes one pixel.

6. A field emission display device according to claim 2, wherein, the control electrode has an acceleration electrode thereon by way of an insulation layer.

7. A field emission display device according to claim 3, wherein, the control electrode has an acceleration electrode thereon by way of an insulation layer.

8. A field emission display device comprising:
a back face plate which includes a plurality of cathode lines having electron sources, a plurality of control electrodes being arranged over the cathode lines in a transverse manner and having aperture regions which allow electrons to pass therethrough and a back face substrate; and
a front face plate which includes an anode and phosphors, wherein the control electrodes are formed of a plate-like member having leg portions and an insulation layer is formed over the back face substrate except for positions where the leg portions are adhered.
